(19) United States
(12) Patent Application Publication
(10) Pub. No.: US 2023/0103313 A1
(43) Pub. Date: Apr. 6, 2023

(54) USER ASSISTANCE SYSTEM

(71) Applicant: Ichiro MIKI, Tokyo (JP)

(72) Inventor: Ichiro MIKI, Tokyo (JP)

(21) Appl. No.: 17/959,565

(22) Filed: Oct. 4, 2022

(30) Foreign Application Priority Data
Oct. 6, 2021 (JP) 2021-164763

(51) Int. Cl. G10L 15/22; G10L 15/08

(52) U.S. Cl. CPC G10L 15/22; G10L 15/08; G10L 2015/223; G10L 2015/221; G10L 2015/088

(57) ABSTRACT

A user assistance system for handling software is provided with an excellent usability. A user assistance system includes acquisition means, selection means, and presentation means. The acquisition means acquires text data input from a user. The selection means refers to a selection model indicating a relation between a preliminarily acquired word group including one or more words and function information regarding a function of software, and selects the function information relative to a word group including one or more words included in the text data acquired by the acquisition means. The presentation means presents the function information selected by the selection means to the user.

### BACKGROUND

### 1. Technical Field

The present invention relates to a user assistance system for handling software by a user.

### 2. Related Art

Recently, with the diversity of users performing creative works for producing contents, new software for improving the qualities of the creative works has become diverse.

In association with this, it has become difficult to find software appropriate for a user from a wide variety of software. In view of this, a software material selection support program configured to present function information regarding a function of software required by a user to the user has been required (for example, see JP-A-2018-120381).

JP-A-2018-120381 discloses a software material selection support device and a software material selection support program configured to search a software material relating to a term that appears in a document explaining software as a development object from usage trend relation information indicating a relation between the term and the software material, and present the searched software material as a candidate.

Meanwhile, in the users who perform the creative works, many users do not have know-how for handling software. Such users do not have know-how for handling technical terms regarding software in a context or the like.

Here, the term that appears in a document explaining software as a development object includes mainly technical terms in a context or the like. However, the user without the know-how for handling software cannot handle the technical terms in a context or the like. Therefore, in the technique disclosed in JP-A-2018-120381, there is a problem that know-how for handling technical terms in a context or the like is required of a user for searching a software material by using a term that appears in a document explaining software as a development object.

Accordingly, the present invention is devised in consideration of the above-described problem, and has an object to provide a user assistance system for handling software with an excellent usability.

### SUMMARY

A user assistance system according to the first invention includes acquisition means, selection means, and presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The selection means refers to the selection model indicating the relation, and the selection model is generated by a machine learning in which a data set that includes input data including a preliminarily acquired word group and output data including function information is used as learning data, and an input is the input data and an output is the output data.

In the user assistance system according to the second invention, in the first invention, the selection means causes the selection model to perform a machine learning as needed by using a data set that includes input data including an additionally acquired word group and output data including function information corresponding to the word group as learning data.

A user assistance system according to the third invention includes acquisition means, selection means, and presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The selection means acquires text data additionally input from the user, and includes one or more words included in the text data acquired by the acquisition means in a word group including a word included in the additionally input text data.

A user assistance system according to the fourth invention includes acquisition means, selection means, presentation means, and usage example presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The usage example presentation means presents effect information regarding an effect of the function included in the function information included in the output data selected by the selection means.

A user assistance system according to the fifth invention includes acquisition means, selection means, and presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The selection means refers to a selection model indicating a relation between the output data including the function information and the input data including the word group, and the function information is generated based on configuration information describing a configuration including an identification word extracted from a document explaining software by referring to a preliminarily acquired identification word for identifying the configuration of the software.

A user assistance system according to the sixth invention includes acquisition means, selection means, and presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The presentation means refers to preliminarily acquired user information regarding the user, and determines one or more pieces of the function information to be presented to the user from the function information included in the output data selected by the selection means.

In the user assistance system according to the seventh invention, in the sixth invention, the presentation means refers to the user information that includes association degrees between information regarding usage frequencies of the software and the function of the software of the user and respective pieces of the function information.

A user assistance system according to the eighth invention includes acquisition means, selection means, and presentation means. The acquisition means acquires text data input from a user. The selection means refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means. The presentation means presents the function information included in the output data selected by the selection means to the user. The acquisition means further acquires user information regarding the user. The selection means refers to a selection model indicating a relation between input data including a word group and user information acquired in advance and the output data including the function information, and selects one or more pieces of the output data including the function information relative to the input data including the word group and the user information acquired by the acquisition means.

In the user assistance system according to the ninth invention, in the eighth invention, the acquisition means acquires answer data indicating an answer of the user relative to question data, repeatedly generates additional question data based on the answer data for multiple times, and acquires user information that includes a plurality of pieces of the acquired answer data.

In the user assistance system according to the tenth invention, in the eighth invention or the ninth invention, the acquisition means acquires user information including information regarding usage frequencies of the software and the function of the software of the user.

In the user assistance system according to the eleventh invention, in any one of the first invention to the tenth invention, the presentation means presents the function information to the user by a sign through which a background is visible on a screen of a monitor or a sound.

In the user assistance system according to the twelfth invention, in any one of the first invention to the eleventh invention, the acquisition means acquires a sound input from the user, and acquires the text data from the sound using a speech recognition.

According to the first invention to the twelfth invention, the user assistance system of the present invention refers to a selection model indicating a relation between a preliminarily acquired word group including one or more words and function information regarding a function of the software, and selects the function information relative to a word group including one or more words included in the text data. Accordingly, for example, by including a plurality of similar words such as “fluffiness” and “fluffy” in the word group, the function information corresponding to the word can be acquired from an abstract word. Therefore, a user assistance system for handling software can be provided with more excellent usability.

Especially, according to the first invention, the user assistance system of the present invention refers to the selection model indicating the relation generated by the machine learning in which a data set that includes a preliminarily acquired word group and function information is used as learning data, and the input is the word group and the output is the function information. Accordingly, since the word group can be associated with the function information using the relation of three or more levels, the function information more appropriate for the input word group can be selected.

Especially, according to the second invention, the user assistance system of the present invention causes the selection model to perform a machine learning as needed by using a data set that includes an additionally acquired word group and function information corresponding to the word group as learning data. Accordingly, since the learning can be sequentially and repeatedly performed, the function information more appropriate for the input word group can be selected.

Especially, according to the eleventh invention, the user assistance system of the present invention presents the function information to the user by a sign through which a background is visible on a screen of a monitor or a sound. Accordingly, since the function information can be presented to the user without hindering the operation of the user, a user assistance system for handling software can be provided with more excellent usability.

Especially, according to the twelfth invention, the user assistance system of the present invention acquires a sound input from the user, and acquires the text data from the sound using a speech recognition. Accordingly, since the text data can be acquired from the sound input from the user, a user assistance system for handling software can be provided with more excellent usability.

Especially, according to the third invention, when one or more words included in the text data acquired by the acquisition means are not included in the word group, the user assistance system of the present invention acquires text data additionally input from the user, and includes one or more words included in the text data acquired by the acquisition means in the word group including a word included in the additionally input text data. Accordingly, even when the word group including an input word is not present in the selection model, since the word can be automatically included in the word group, a user assistance system for handling software can be provided with more excellent usability.

Especially, according to the fourth invention, the user assistance system of the present invention further includes usage example presentation means that presents effect information regarding an effect of the function included in the function information selected by the selection means. Accordingly, for example, since a usage example when a function is used can be presented as the effect information, a user assistance system for handling software can be provided with more excellent usability.

Especially, according to the fifth invention, the user assistance system of the present invention refers to processing words for identifying the process of the software, and extracts process information describing a process including a processing word from a text describing the software. Accordingly, for example, since the function information based on the process information acquired from a source code can be acquired, the function information can be easily acquired. Even when a word group relative to an input word is not present in the selection model, since the word can be automatically included in the word group, the function information more appropriate for the input word can be selected.

Especially, according to the sixth invention, the user assistance system of the present invention refers to preliminarily acquired user information regarding the user, and determines one or more pieces of the function information to be presented to the user from the function information selected by the selection means. Accordingly, since the function information more appropriate for the user can be presented, a user assistance system for handling software can be provided with more excellent usability.

Especially, according to the seventh invention, the user assistance system of the present invention refers to the user information that includes the association degree between information regarding usage frequency of the software of the user and respective pieces of the function information. Accordingly, for example, the software having the high usage frequency of the user can be extracted from the information regarding the usage frequency, and the function information having the high association degree with the function information of the extracted software can be selected from the function information selected by the selection means. Therefore, since the function information more appropriate for the user can be presented, a user assistance system for handling software can be provided with more excellent usability.

Especially, according to the eighth invention, the user assistance system of the present invention refers to a selection model indicating a relation between a word group and user information acquired in advance and the function information, and selects one or more pieces of the function information relative to the word group and the user information. Accordingly, since the function information more appropriate for the user can be presented, a user assistance system for handling software can be provided with more excellent usability.

Especially, according to the ninth invention, the user assistance system of the present invention acquires answer data, repeatedly generates additional question data based on the answer data for multiple times, and acquires user information that includes a plurality of pieces of the acquired answer data. Accordingly, information regarding the function information required by the user can be acquired in more detail. Accordingly, a user assistance system for handling software can be provided with more excellent usability.

Especially, according to the tenth invention, in the user assistance system of the present invention, the acquisition means acquires user information including information regarding usage frequencies of the software and the function of the software of the user. Accordingly, the function information that the user frequently uses can be acquired. Accordingly, a user assistance system for handling software can be provided with more excellent usability.

### BRIEF DESCRIPTION OF THE DRAWINGS

FIG. 1 is a drawing illustrating a user assistance system in an embodiment;

FIG. 2 is a schematic diagram illustrating an exemplary configuration of a user assistance device;

FIG. 3 is a schematic diagram illustrating an exemplary function of the user assistance device;

FIG. 4 is a flowchart for describing the user assistance device;

FIG. 5 is a drawing illustrating an exemplary operation of extracting process information;

FIG. 6 is a drawing illustrating an association between a reference word group and function information;

FIG. 7 is a drawing illustrating an association between the reference word group and the function information when a hidden layer is provided;

FIG. 8 is a drawing illustrating an exemplary operation of a usage example presentation unit;

FIG. 9 is a drawing illustrating an exemplary operation of a presentation unit;

FIG. 10 is a drawing illustrating a correspondence table between question data and answer data; and

FIG. 11 is a drawing illustrating an association between the reference word group and reference user information, and the function information.

### DETAILED DESCRIPTION

### First Embodiment

The following describes an example of a user assistance system according to the first embodiment of the present invention with reference to the drawings.

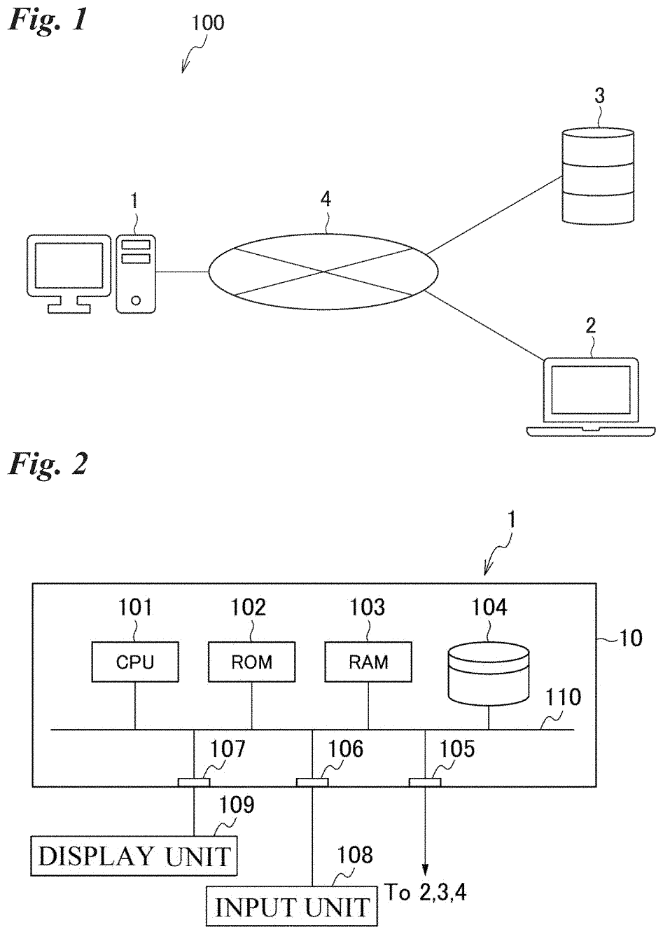

FIG. 1 is a drawing illustrating a user assistance system 100 according to the first embodiment. A user assistance device 1 is connected to a user terminal 2 and a server 3 via a communication network 4.

The user assistance device 1 is a computer that acquires text data from the user terminal 2 via the communication network 4, and selects output data including function information regarding a function of software relative to input data including a word group including one or more words included in the text data.

The user terminal 2 is a terminal, such as a smartphone, a tablet terminal, a personal computer, a wearable device, and a mobile phone, in which an application for acquiring the text data is installed. The user terminal 2 may include the user assistance device 1. In this case, the user terminal 2 may communicate with the user assistance device 1 without via the communication network 4.

The server 3 is a server that stores various kinds of information, for example, the text data acquired by the user terminal 2, the word and the word group, and the function information, and any type, such as a cloud server and an ASP server, is possible.

The communication network 4 is an Internet network or the like in which the user assistance device 1, the user terminal 2, and the server 3 are connected via a communication line. The communication network 4 may be configured by a Local Area Network (LAN) when the user assistance system 100 is operated in a certain narrow area. The communication network 4 may be configured by what is called an optical fiber communications network. The communication network 4 is not limited to a wired communication network, and may be achieved by a wireless communication network. The following describes the configuration of the user assistance device 1 in detail.

FIG. 2 is a schematic diagram illustrating an exemplary configuration of the user assistance device 1. As the user assistance device 1, known electronic equipment, for example, a personal computer (PC), a smartphone, or a tablet terminal is used. The user assistance device 1 includes, for example, a housing 10, a Central Processing Unit (CPU) 101, a Read Only Memory (ROM) 102, a Random Access Memory (RAM) 103, a storage unit 104, I/Fs 105 to 107, an input unit 108, and a display unit 109. The components 101 to 107 are mutually connected by an internal bus 110.

The CPU 101 controls the whole user assistance device 1. The ROM 102 stores an operation code of the CPU 101. The RAM 103 is a work area used during an operation of the CPU 101. The storage unit 104 stores various kinds of information such as process data. As the storage unit 104, for example, a Hard Disk Drive (HDD) or a Solid State Drive (SSD) is used.

The I/F 105 is an interface for transmitting and receiving various kinds of information with the user terminal 2, the server 3, the communication network 4, and the like. The I/F 106 is an interface for transmitting and receiving various kinds of information with the input unit 108. The I/F 107 is an interface for transmitting and receiving various kinds of information with the display unit 109.

As the input unit 108, a keyboard is used, and additionally, for example, a sound pickup device such as a microphone may be used. Various kinds of information on text data, a sound, and the like are input by a user of the user assistance device 1 to the input unit 108.

The display unit 109 displays various kinds of information and the like of a conversational sentence and the like stored in the storage unit 104. As the display unit 109, for example, a display and a monitor are used, and additionally, for example, a speaker is used.

For example, the I/F 105 to the I/F 107 may be the same interface, and for example, a plurality of interfaces may be used for each of the I/F 105 to the I/F 107. When a touch panel display is used, the display unit 109 may have a configuration including the input unit 108.

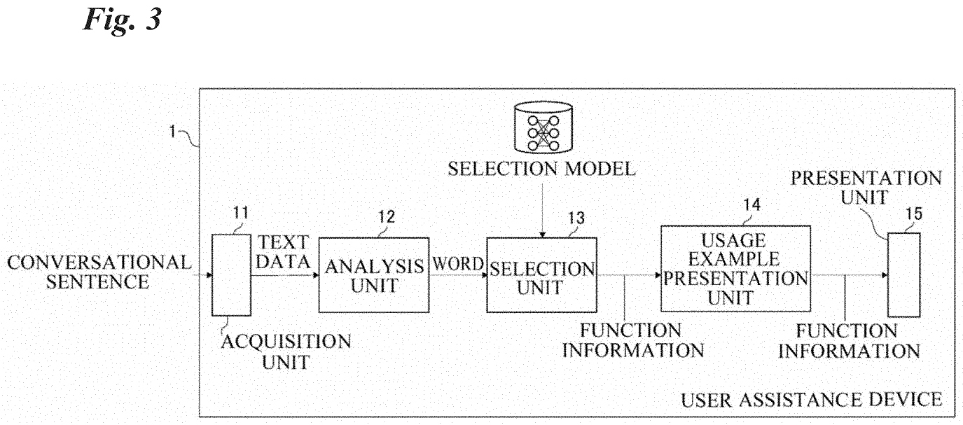

FIG. 3 is a schematic diagram illustrating an exemplary function of the user assistance device 1. The user assistance device 1 may include an acquisition unit 11, an analysis unit 12 connected to the acquisition unit 11, a selection unit 13 connected to the analysis unit 12, a usage example presentation unit 14 connected to the selection unit 13, and a presentation unit 15 connected to the usage example presentation unit 14. The CPU 101 executes a program stored in the storage unit 104 and the like with the RAM 103 as the work area, and thus the user assistance device 1 is achieved. The user assistance device 1 may be controlled by an artificial intelligence. Here, the artificial intelligence may be based on any known artificial intelligence technology.

The acquisition unit 11 acquires text data input via a sound or an input terminal. For example, the acquisition unit 11 acquires text data input from a user via the user terminal 2 or the input unit 108. For example, when a conversational sentence is input from the user by a sound via the user terminal 2 or the input unit 108, the acquisition unit 11 acquires text data generated from the sound by using a known speech recognition technology (for example, phoneme recognition technology). As the speech recognition technology, for example, a cloud-based speech recognition technology may be used via the communication network 4. The acquisition unit 11 outputs the input text data to the analysis unit 12.

The analysis unit 12 performs, for example, a natural language analysis such as a morphological analysis for the text data input from the acquisition unit 11, thereby extracting individual words in the sentence including a verb, a noun, a case component, and the like. The analysis unit 12 outputs the extracted words to the selection unit 13.

The selection unit 13 refers to a selection model indicating a relation between a word group and function information, and selects the function information corresponding to the word group including the word input from the analysis unit 12 using the selection model. The selection unit 13 outputs the selected function information to the usage example presentation unit 14.

The usage example presentation unit 14 presents effect information regarding an effect of the function included in the function information input from the selection unit 13. The usage example presentation unit 14 outputs, for example, the function information selected by the user to the presentation unit 15.

The presentation unit 15 presents the function information. The presentation unit 15 presents the function information via the display unit 109, the user terminal 2, or the like so as to be recognizable to the user. The presentation unit 15 may output the function information or the like to the user terminal 2 or the like via the I/F 105, and may present the function information and the like via a display or a monitor provided to the user terminal 2.

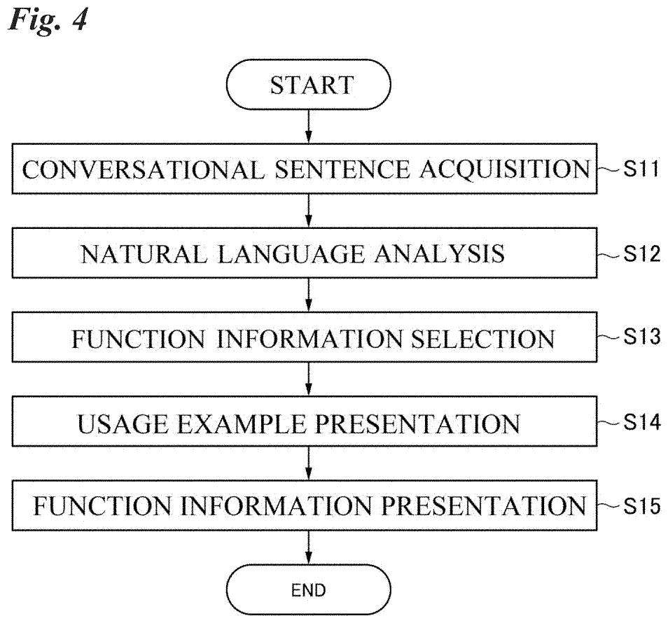

Next, an operation of the user assistance device 1 in the embodiment to which the present invention is applied will be described. As illustrated in FIG. 4, a conversational sentence is acquired in Step S11. The conversational sentence is a sentence of a human conversation, and may be referred to as a sentence of a nature language. While the acquisition of the conversational sentence is, for example, an acquisition of a sound, it may be an acquisition of text data. The sound is a voice emitted by a human. The text data is a character string obtained from the voice emitted by a human by a speech recognition, or a character string input by a keyboard or the like. The character string includes an arrangement of one or two or more characters. Specifically, when a conversational sentence is acquired as sound data by the acquisition unit 11, text data is generated from this by using a known speech recognition technology (for example, phoneme recognition technology).

Next, the process proceeds to Step S12, the text data acquired in Step S11 and temporarily stored in a memory (not illustrated) is read, and for example, a morphological analysis as a natural language analysis is performed to the text data. The morphological analysis is mainly performed by the analysis unit 12. As the morphological analysis technique, any known morphological analysis technique may be used. The words in the text data to which the morphological analysis has been performed are output to the selection unit 13. As another example of the natural language analysis performed by the analysis unit 12, a parsing, a synonym extraction, a span extraction, an implication recognition, and the like may be performed.

The parsing is referred to as a dependency parsing, and is an analysis method in which dependency relations in naturalness among words and segments are calculated while satisfying a predetermined structural constraint, and the dependency relations among words and segments are determined.

The synonym extraction is an analysis method in which text data as a processing target is input, and a pair of synonyms that are different in notation but the same in meaning is extracted. The synonyms may be extracted and stored for each specific domain (field) such as an IT-related, a machine-related, and a cooking-related.

The span extraction is an analysis method in which an important part is automatically clipped and extracted from the input text data using a model learned from learning data. As a representative method of the span extraction, Conditional Random Field (CRF) is included. For example, a case where three sentences of “I will go to Hawaii on a trip with my family,” “I will go to America on a trip next month,” and “the destination is New York” are input as the learning data is described. In this case, by learning the learning data, it is seen that a word after “go” +“to” and before “on” +“a trip” is highly possibly a destination. Consequently, when a sentence “I will go to Italy on a trip” is input as unknown data, “Italy” can be extracted as the destination. The “implication recognition” is an analysis method in which whether one text includes a meaning indicated by another text or not is determined for the two texts.

As the result of the morphological analysis in Step S12, the words included in the conversational sentence are extracted. The words are usually independent words. The independent word is a word that can constitute a segment alone, and is, for example, a noun, but may be a verb, an adjective, and the like. However, a corresponding word may be an attached word. The attached word is a word that cannot constitute a segment alone and constitutes a segment with another independent word, and is, for example, an auxiliary verb, a particle, and the like. That is, while a corresponding word is usually an independent word, it may be an independent word with an attached word.

The word may be, for example, a collocation. The collocation is words in which two or more independent words are combined and indicate a certain meaning, and may be referred to as a compound word. The collocation may be any words insofar as two or more words are combined, for example, a “soft sound” in which “soft” and “sound” are coupled, and a “synthetic sound” in which “synthetic” and “sound” are coupled.

Next, the process proceeds to Step S13, the selection unit 13 refers to a selection model indicating a relation between a word group and function information, and selects the function information corresponding to the word group including the one or more words included in the text data acquired in the acquiring step S11. The word group is a group including one or more words, and for example, may be a group including a plurality of words having a similar meaning. The word group may be a group including words that are the same in meanings but different in part of speech, for example, “fluffiness” and “fluffy.” The function information is information regarding a function of the software. The information regarding the function of software may be, for example, a name of the function of the software, information explaining the function, a method for using software, a manual, and the like, or information regarding various kinds of materials included in the software. The software may be, for example, a drawing tool, an image editing program, a music composition tool, and the like. The function information may be, for example, a method for using the materials, such as an “acrylic brush,” an “oil brush,” a “colored pencil,” and a “crayon” in the drawing tool.

First, for the word to which the natural language analysis has been performed in Step S12, the selection unit 13 selects the word group including the word. At this time, a synonym dictionary stored in the storage unit 104 may be referred to, thereby selecting the word group relative to the word. The synonym dictionary is a dictionary of synonyms. In the synonym dictionary, for example, a word and one or two or more synonyms of the word are registered in association in each of the one or more word groups stored in the storage unit 104. Specifically, for example, “fluffiness,” “fluffy,” and the like may be registered as a word group corresponding to a word group “soft.” Then, via the synonym dictionary, whether a newly acquired word is similar to a word in the synonym dictionary or not can be determined. Provisionally, when the word group in the synonym dictionary is “soft” and a newly acquired word is “fluffiness,” it can be determined that the word “fluffiness” is included in the word group “soft” because the word “fluffiness” is registered in advance as a similar word in the synonym dictionary. When the word is included in a plurality of word groups, the plurality of word groups including the word may be selected. For example, when the word group including the word is not registered in the above-described synonym dictionary, text data may be additionally acquired from the user, and the word may be included in a word group including a word included in the text data and registered. In this case, for example, when the word “fluffiness” to which the natural language analysis has been performed in Step S12 is not included in the words of the synonym dictionary, text data is additionally acquired from the user, and the morphological analysis is performed. Consequently, when the additionally acquired text data includes a word “fluffy” registered in the word group “soft” of the synonym dictionary, the previously acquired word “fluffiness” may be registered in the word group “soft.” Accordingly, even when a word group relative to an input word is not present in the selection model, since the word can be automatically included in a word group, a user assistance system for handling software can be provided with more excellent usability. In a case where the word group including the word is not registered in, for example, the above-described synonym dictionary, when text data is additionally acquired from the user, and the word is included in a word group including a word included in the text data and registered, whether to include the word in the word group or not may be asked to the user before the registration, answer information to the question may be acquired, and whether to register or not may be determined based on the answer information. In this case, the word, the word group, and the answer information may be configured as one data set, and a learning model may be generated using a plurality of data sets. Accordingly, even when a word group relative to an input word is not present in the selection model, since the word can be automatically included in a word group with higher accuracy, a user assistance system for handling software can be provided with more excellent usability.

Next, in Step S13, the selection model is referred to, and the function information relative to the selected word group is selected.

The selection model is a model indicating a relation between input data including preliminarily acquired word groups and output data including function information. The selection model may be, for example, a relation table including the function information corresponding to the word group as illustrated in Table 1. For example, when text data of “a material of a fluffy sound is wanted” is input as text data, assuming that the analysis unit 12 performs the morphological analysis and “a material of/a fluffy/sound/is wanted” is obtained, the selection unit 13 may select function information B corresponding to the word group “soft” including the word “fluffy” using the selection model.

TABLE 1

| Word Group | Word | Function Information |
|---|---|---|
| Weighty | Heavy | Function Information A |
| | Dark | |
| | Significant | |
| Soft | Flufly | Function Information B |
| | Mild | |
| | Pale | |
| Large | Huge | Function Information C |
| | Maximal | |
| | Enormous | |

The selection model may be a trained model generated by a machine learning in which a data set that includes input data including preliminarily acquired reference word groups and output data including function information is used as learning data, and an input is the reference word group and an output is the function information. The reference word group is a word group used as input data of the learning data, and one having a data format the same as that of the word group may be used.

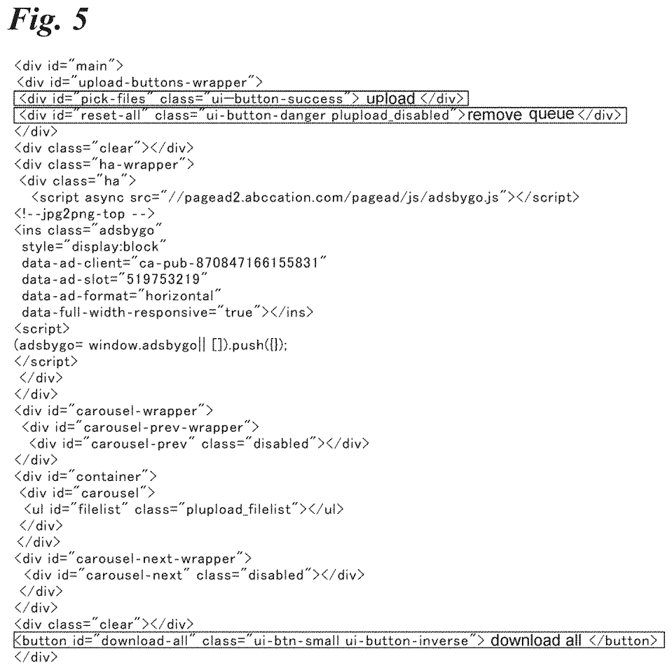

The function information used for the output data of the selection model may be generated based on configuration information describing a configuration including an identification word extracted from a document explaining the software by referring to a preliminarily acquired identification word for identifying the configuration of software. The document describing the software may be a written explanation or a manual of the software, or a source code of the software. The identification word is a preliminarily acquired word used for identifying the configuration of the software from the document explaining the software. The identification word includes, for example, a “button.” The configuration information is information regarding the configuration of the software. The configuration information includes, for example, an upload button, a download button, and the like. In this case, for example, as illustrated in FIG. 5, the word “button” included in the identification word is referred to from the source code of the software posted in HTML, format on a browser, codes including the above-described word are extracted, and configurations such as a “button for uploading,” a “button for deleting a queue,” and a “button for downloading all” indicated by the extracted codes are acquired as the configuration information. Then, the function information is generated based on the configuration information.

As a generation method of the selection model, the selection model may be generated, for example, by using a machine learning having a neural network as a model. The selection model is generated by using a machine learning having a neural network such as Convolution Neural Network (CNN) as a model, and additionally, any model may be used.

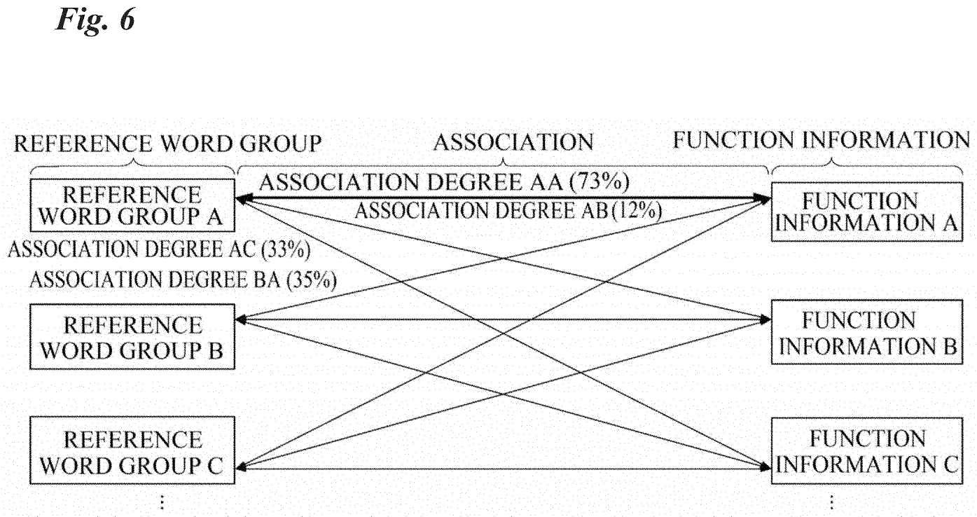

In this case, for example, as illustrated in FIG. 6, the selection model stores an association having an association degree between the reference word group and the function information. The association degree indicates a degree of connection between the reference word group and the function information, and for example, it can be determined that the higher the association degree is, the stronger the connection between data is. For example, the association degree is indicated in ternary or more, such as percentage or the like, or three levels or more, and additionally, may be indicated in binary or two levels.

For example, the association is established by a degree of connection among a plurality of the reference word groups, a pair, and a plurality of pieces of the function information. The association is appropriately updated during the process of the machine learning, and for example, means a classifier using a function optimized based on the plurality of reference word groups and the plurality of pieces of function information. For example, the association may have a plurality of association degrees indicating the degrees of connection between respective pieces of data. For example, when a database is established by a neural network, the association degree can be corresponded to a weight variable. For example, as illustrated in FIG. 6, the association may indicate the degree of connection between the plurality of reference word groups and the plurality of pieces of function information. In this case, by using the association, degrees of the relation with the plurality of pieces of the function information of from “function information A” to “function information C” can be stored in association with each of the reference word groups of from a “reference word group A” to a “reference word group C” illustrated in FIG. 6. Therefore, for example, via the association, a plurality of the reference word groups can be associated with one piece of the function information. Additionally, the multifaceted selection of the function information relative to the word group can be achieved.

For example, the association has a plurality of association degrees in which each piece of the function information is associated with each of the word groups. The association degree is indicated by, for example, a percentage, or three or more levels such as ten levels or five levels, and illustrated by, for example, a feature of a line (for example, a thickness or the like). For example, the “word group A” included in the word group has an association degree AA “73%” with the “function information A” included in the function information, and has an association degree AB “12%” with the “function information B” included in the function information. That is, the “association degree” indicates the degree of connection between the data, and for example, the higher association degree indicates the stronger connection between the data. For example, when the association degree between the word group “soft” and the “function information B” is “92%,” and the association degree between the word group “soft” and the function information referred to as the “function information C” is “5%,” it indicates that the connection between the word group “soft” and the “function information B” is stronger than the connection between the word group “soft” and the “function information C.”

The association degree of three or more levels as illustrated in FIG. 6 is preliminarily acquired. That is, the association degrees illustrated in FIG. 6 are preliminarily produced by accumulating past data sets and performing analytics and analysis on which of the word groups and the function information have been employed and evaluated in the actual determination of estimated solution.

For example, assume that the function information B was determined and evaluated to be the most suitable for the word group “soft” in the past. By collecting and performing analytics on the data sets like this, the association degree between the reference word group and the function information is increased.

The analytics and analysis may be performed by an artificial intelligence. In this case, for example, when the input word group is “soft,” the association degree connecting the “soft” to the function information B is set to be higher when the number of cases in which the function information B is estimated is large based on the past data sets.

The association degree may be configured of nodes of a neural network in the artificial intelligence. That is, the nodes of the neural network function as weighting factors to the output, and correspond to the above-described association degree. Not limited to the neural network, the association degree may be configured of any decision factor constituting the artificial intelligence.

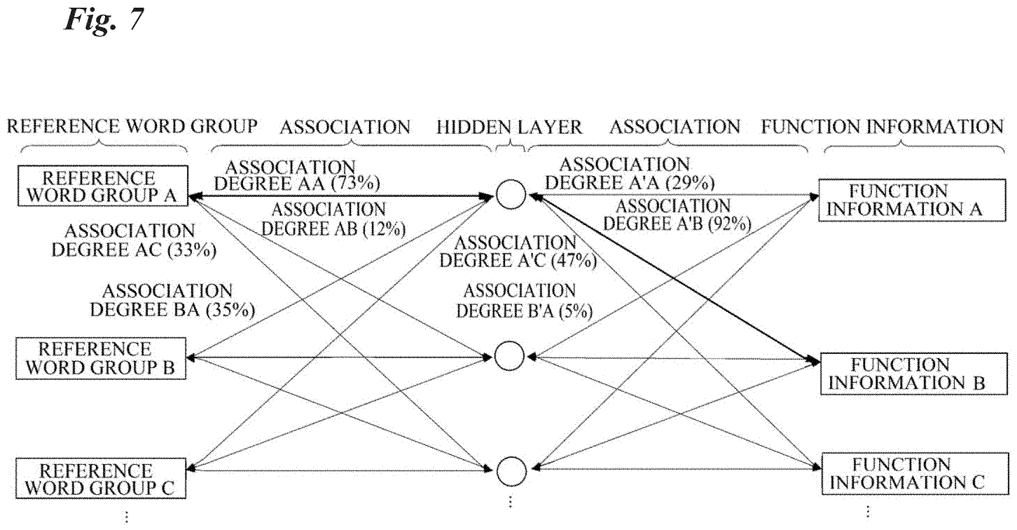

As illustrated in FIG. 7, in the selection model, the reference word group may be input as input data, the function information may be output as output data, and at least one or more hidden layers may be provided between the input data and the output data, and the selection model may perform a machine learning. The above-described association degree is set to any one of the input data or hidden layer data or both of them, the association degree functions as weighting of each data, and the output is selected based on this. Then, the output may be selected when the association degree exceeds a certain threshold value.

The association degree as described above is used as trained data in the artificial intelligence. After creating the trained data like this, actually, the function information is additionally estimated from the word group based on the trained data. In this case, a word group relative to the word extracted in Step S12 is additionally acquired. Based on the additionally acquired word group, the function information corresponding to this is estimated. In the estimation, for example, the preliminarily acquired association degree as illustrated in FIG. 6 is referred to. For example, when the additionally acquired word group is the same as or similar to the “reference word group A,” the additionally acquired word group is associated with the “function information A” by the association degree AA “73%,” and associated with the “function information B” by the association degree AB “12%” via the association degree. In this case, the “function information A” having the highest association degree is selected as an optimal solution. However, it is not required to select one having the highest association degree as the optimal solution, and the “function information B” in which the association itself is recognized while the association degree is low may be selected as the optimal solution. Of course, an output solution not connected by an arrow may be selected in addition to this, and the selection may be performed with any other priority order insofar as the priority order is based on the association degree.

By referring to the association degree as described above, in addition to a case where the word group is the same as or similar to the function information, even in a case of being not similar, since the function information appropriate for the word group can be quantitatively selected, which function information the word group extracted from the conversational sentence corresponds to can be accurately determined. Accordingly, since the word group can be associated with the function information using the relation of three or more levels, the function information more appropriate for the input word can be selected. The selection model may perform a reinforcement learning using the input data input in Step S13 and the output data selected in Step S13 as learning data.

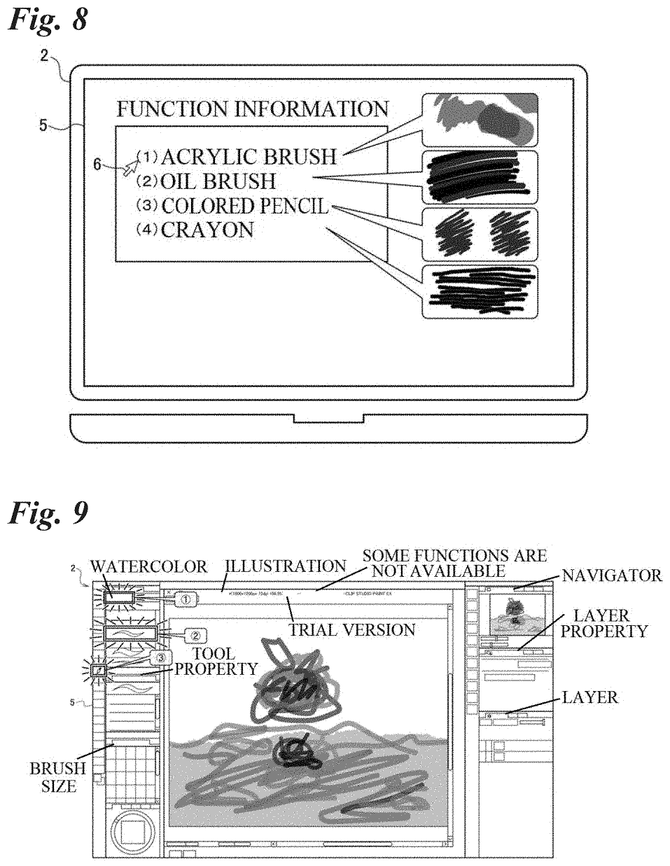

Next, the process proceeds to Step S14, and the usage example presentation unit 14 presents effect information corresponding to the function information selected in Step S13. The effect information is information regarding the effect of the function. For example, the effect information is information indicating the effect when the function explained by the function information is used, and may present a usage example when the function is used. As illustrated in FIG. 8, for example, when a plurality of pieces of the function information are selected in Step S13, the usage example presentation unit 14 may present the effect information to the user by using translucent signs through which a background is visible on a screen of a monitor 5 when a cursor 6 is overlapped with an icon indicating the function information on the screen of the monitor 5. In this case, for example, when the “acrylic brush,” the “oil brush,” the “colored pencil,” and the “crayon” are acquired as the function information, the usage example presentation unit 14 may display usage examples in the cases where the respective materials are used on the monitor 5 as the effect information. For example, the usage example presentation unit 14 may output the function information selected from a plurality of pieces of the function information by the user to the presentation unit 15.

Next, the process proceeds to Step S15, and the presentation unit 15 presents the function information selected in Step S14. For example, as illustrated in FIG. 9, the presentation unit 15 may present the function information to the user by using translucent signs through which a background is visible on the screen of the monitor 5 of the user terminal 2. The presentation unit 15 may present the function information by using a sound. Accordingly, since the function information can be presented to the user without hindering the operation of the user, a user assistance system for handling software can be provided with more excellent usability.

In Step S15, the presentation unit 15 may refer to preliminarily acquired user information regarding the user, and may determine one or more pieces of the function information to be presented to the user from the function information selected in Step S13. The user information is information regarding the user, and for example, information regarding user attributes such as an age and a gender of the user, a preference of the user, a usage history and a usage frequency of software and a function of the software of the user, or software and a function of the software in use of the user. The user information may include the association degrees of respective pieces of the function information. The association degrees of respective pieces of the function information are information indicating the association degrees between the respective pieces of the function information, and for example, indicate a degree of relation between function information a and function information b. When the information regarding the software and the function of the software used by the user is acquired as the user information, and the acquired function information of the software is included in the function information selected in Step S13, the function information may be determined not to be presented to the user.

When function information of software with a high usage frequency by another user having the same attribute as the user is included in the function information selected in Step S13, the function information may be determined to be presented to the user. In this case, a list of usage frequency of the software may be generated for each of the user attributes, the user information may be referred to the list, and then, the function information of the software may be determined to be presented to the user.

When function information of software similar to the software and the function of the software frequently used by the user is included in the function information selected in Step S13, the function information may be determined to be presented to the user. In this case, by referring to the usage frequency or the usage history of the software and the function of the software of the user included in the user information, the function information having the high association degree with the function information of the software with the high usage frequency may be presented to the user. In this case, the preliminarily acquired association degrees of the respective pieces of function information may be referred to. The association degrees of the respective pieces of the function information are data indicating the association degrees between the respective pieces of the function information, and for example, data indicating that the function information A and the function information B are associated with the association degree of 30%, the function information A and the function information C are associated with the association degree of 70%, and the function information B and the function information C are associated with the association degree of 50%. A function information group in which the function information of a plurality of pieces of similar software are mutually associated may be preliminarily acquired, and the function information to be presented to the user may be determined by referring to the above-described function information group.

### Second Embodiment

The following describes an example of a user assistance system according to the second embodiment of the present invention with reference to the drawings. The second embodiment is different from the first embodiment in that the selection model indicating the relation between the input data including the preliminarily acquired word groups and user information and the output data including the function information is referred to, and one or more pieces of function information relative to the word group and the user information are selected. Explanations of components similar to those in the first embodiment are omitted.

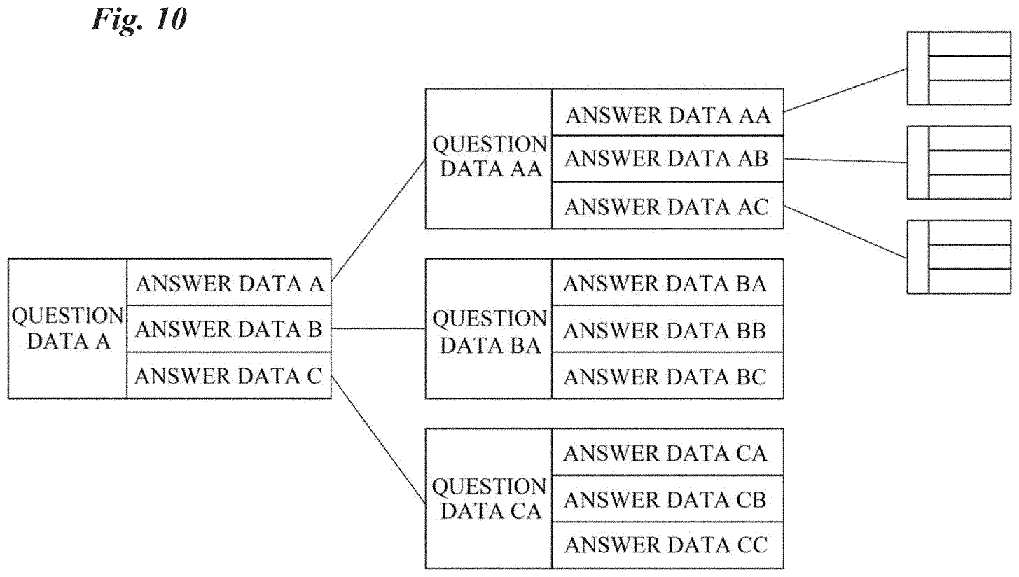

In the second embodiment, user information is acquired in Step S11. In this case, the user information includes answer data indicating an answer of the user to question data. The question data is data on questions for identifying software and a function of the software that the user wants to use, and may be, for example, data on questions about trends or the like of the software and the function of the software. The answer data is answers of the user to the question data, and may be, for example, data including a plurality of options as illustrated in FIG. 10. When the answer data is acquired, question data may be additionally generated based on the acquired answer data, and answer data to the question data may be further acquired. In this case, in Step S11, the user information including a plurality of pieces of answer data may be acquired by repeatedly performing referring to a correspondence table of the question data and the answer data as illustrated in FIG. 10, additionally generating question data based on the acquired answer data, and further acquiring answer data to the question data for multiple times. Accordingly, information regarding the function information required by the user can be acquired in more detail, thereby allowing providing a user assistance system for handling software with more excellent usability. The user information may include the information regarding the usage history and the usage frequency of the software and the function of the software of the user.

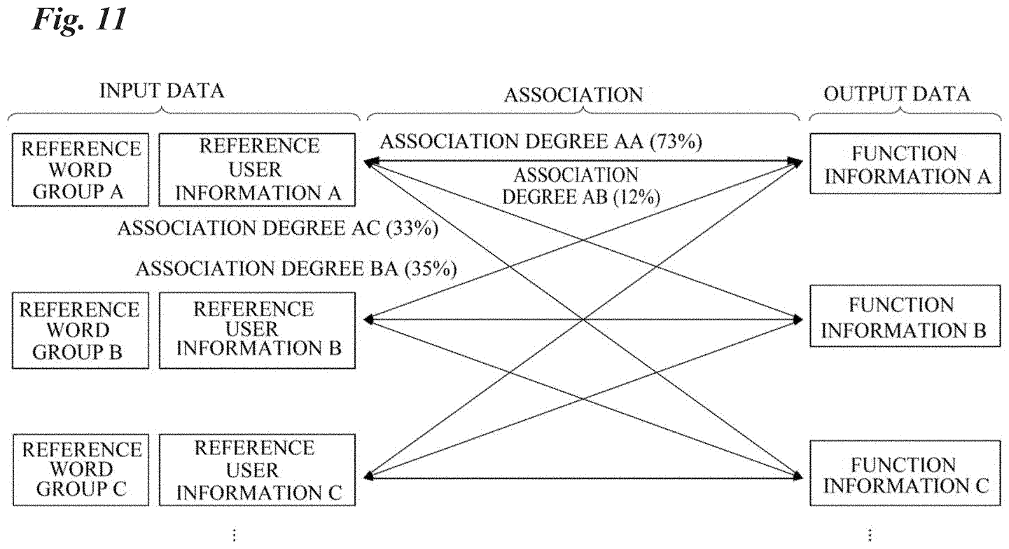

In the second embodiment, in Step S13, the selection unit 13 refers to the selection model indicating the relation between the input data including the preliminarily acquired word group and user information and the output data including the function information, and selects one or more pieces of the output data including the function information relative to the input data including the word group and the user information acquired in Step S11. In this case, the selection model is a model indicating the relation between the input and the output using the word group and the user information as the input and the function information as the output. For the selection model, for example, the selection model may be generated using a machine learning having a neural network as a model. In this case, for example, as illustrated in FIG. 11, the selection model stores the association having the association degree between the reference word group and the reference user information, and the function information. The selection model is different from that of the first embodiment in that the input data includes reference user data. Accordingly, since the function information more appropriate for the user can be presented, a user assistance system for handling software can be provided with more excellent usability.

While the embodiments of the present invention have been described, the embodiments have been presented as examples, and are not intended to limit the scope of the invention. The novel embodiments described herein can be embodied in a variety of other configurations. Various omissions, substitutions, and changes can be made without departing from the gist of the invention. The embodiments and the modifications thereof are within the scope and the gist of the invention and within the scope of the inventions described in the claims and their equivalents.

### DESCRIPTION OF REFERENCE SIGNS

1: User assistance device

2: User terminal

3: Server

4: Communication network

5: Monitor

6: Cursor

10: Housing

11: Acquisition unit

12: Analysis unit

13: Selection unit

14: Usage example presentation unit

15: Presentation unit

100: User assistance system

101: CPU

102: ROM

103: RAM

104: Storage unit

105 to 107: I/F

108: Input unit

109: Display unit

S11: Acquiring step

S12: Analyzing step

S13: Selecting step

S14: Usage example presenting step

S15: Presenting step

1. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means; and
presentation means that presents the function information included in the output data selected by the selection means to the user, wherein
the selection means refers to the selection model indicating the relation, and the selection model is generated by a machine learning in which a data set that includes input data including a preliminarily acquired word group and output data including function information is used as learning data, and an input is the input data and an output is the output data.

2. The user assistance system according to claim 1, wherein
the selection means causes the selection model to perform a machine learning as needed by using a data set that includes input data including an additionally acquired word group and output data including function information corresponding to the word group as learning data.

3. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means; and
presentation means that presents the function information included in the output data selected by the selection means to the user, wherein
the selection means acquires text data additionally input from the user, and includes one or more words included in the text data acquired by the acquisition means in a word group including a word included in the additionally input text data.

4. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means;
presentation means that presents the function information included in the output data selected by the selection means to the user; and
usage example presentation means that presents effect information regarding an effect of the function included in the function information included in the output data selected by the selection means.

5. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means; and
presentation means that presents the function information included in the output data selected by the selection means to the user, wherein
the selection means refers to a selection model indicating a relation between the output data including the function information and the input data including the word group, and the function information is generated based on configuration information describing a configuration including an identification word extracted from a document explaining software by referring to a preliminarily acquired identification word for identifying the configuration of the software.

6. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means; and
presentation means that presents the function information included in the output data selected by the selection means to the user, wherein
the presentation means refers to preliminarily acquired user information regarding the user, and determines one or more pieces of the function information to be presented to the user from the function information included in the output data selected by the selection means.

7. The user assistance system according to claim 6, wherein
the presentation means refers to the user information that includes association degrees between information regarding usage frequencies of the software and the function of the software of the user and respective pieces of the function information.

8. A user assistance system comprising:
acquisition means that acquires text data input from a user;
selection means that refers to a selection model indicating a relation between input data including a preliminarily acquired word group including one or more words and output data including function information regarding a function of software, and selects one or more pieces of the output data including the function information relative to the input data including a word group including one or more words included in the text data acquired by the acquisition means; and
presentation means that presents the function information included in the output data selected by the selection means to the user, wherein
the acquisition means further acquires user information regarding the user, and
the selection means refers to a selection model indicating a relation between input data including a word group and user information acquired in advance and the output data including the function information, and selects one or more pieces of the output data including the function information relative to the input data including the word group and the user information acquired by the acquisition means.

9. The user assistance system according to claim 8, wherein
the acquisition means acquires answer data indicating an answer of the user relative to question data, repeatedly generates additional question data based on the answer data for multiple times, and acquires user information that includes a plurality of pieces of the acquired answer data.

10. The user assistance system according to claim 8, wherein
the acquisition means acquires user information including information regarding usage frequencies of the software and the function of the software of the user.

11. The user assistance system according to claim 1, wherein
the presentation means presents the function information to the user by a sign through which a background is visible on a screen of a monitor or a sound.

12. The user assistance system according to claim 1, wherein
the acquisition means acquires a sound input from the user, and acquires the text data from the sound using a speech recognition.
